(19) United States
(12) Patent Application Publication
(10) Pub. No.: US 2010/0113669 A1
(43) Pub. Date: May 6, 2010

(54) THERMOPLASTIC COMPOSITION INCLUDING HYPERBRANCHED AROMATIC POLYAMIDE

(75) Inventors: Yuji Saga, Utsunomiya-Shi (JP); Wei W. Zhang, Zhangjiang Hi-Tech Park (CN)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/582,795

(22) Filed: Oct. 21, 2009

Related U.S. Application Data
(60) Provisional application No. 61/197,778, filed on Oct. 30, 2008.

(51) Int. Cl. C08L 77/10; C08K 3/16; C08L 33/24; C08K 3/22; C08K 3/38; C08K 3/10

(52) U.S. Cl. 524/404; 524/436; 524/538; 524/432; 524/433; 524/435; 524/514; 524/540

(57) ABSTRACT

Disclosed is a thermoplastic composition including at least one semi-aromatic polyamide having a glass transition equal to or greater than 100° C. and a melting point of equal to or greater than 280° C., at least one hyperbranched aromatic polyamide having terminal alkylcarboxamide groups, and, optionally a thermally conductive filler; and molded articles made therefrom.

### CROSS REFERENCE TO RELATED APPLICATIONS

This application claims the benefit of U.S. Provisional Application No. 61/197,778, filed Oct. 30, 2008, which is incorporated herein by reference in its entirety.

### FIELD OF INVENTION

The present invention relates to a thermoplastic composition including a semiaromatic polyamide, thermally conducting filler, a hyperbranched aromatic polyamide and, optionally a thermally conductive filler, the composition having low melt viscosity and high thermal stability.

### BACKGROUND OF INVENTION

Engineering thermoplastic plastics are widely used in automotive, electric/electronic, and industrial applications due to high strength, high stiffness, and high heat stability. Particular applications in the automotive markets require moldable thermoplastics that have the mechanical properties and heat stability comparable to metals, high thermal conductivity, and good moisture stability. Providing high thermal conductivity in thermoplastic compositions typically requires high loading of thermally conducting fillers. Unfortunately high levels of fillers often lead to high viscosity compositions that are difficult to mold, especially were fine details are required. Conventional viscosity modifiers such as organic acids, and low viscosity resins, such as polyamide 6,6, are known to reduce melt viscosity when used as additives. However, these materials also lead to undesirable decreases in moisture resistance and physical properties.

Hyperbranched polymers have been disclosed as viscosity modifiers for thermoplastic resins. “Hyperbranched polymers” means a branched polymer structure obtained by polymerization in the presence of compounds having a functionality of greater than 2, and the structure of which is not fully controlled. European Patent 0902803, for instance discloses hyperbranched polyesters. Although these hyperbranched polyesters exhibit good thermal stability in thermo-gravimetric analysis (TGA) alone; in thermoplastic compositions including high melting (≧280° C.) semiaromatic polyamides, and thermally conducting fillers, thermal stability is surprisingly lacking.

US 2006/0211822 A1 discloses thermoplastic compositions including at least one hyperbranched polymer additive wherein the hyperbranched polymer additive is a hyperbranched polyamide (HBPA). However, hyperbranched polymers having a terminal alkylcarboxamide groups are not disclosed.

Needed are molding compositions having high flow (low viscosity) and high thermal stability at processing temperatures ≧280° C., and preferably ≧280° C., that exhibit high thermal conductivity and good heat and moisture resistance in molded parts.

### SUMMARY OF INVENTION

One embodiment of the invention is a thermoplastic composition comprising:
a) from about 10 to about 99.9 wt % of at least one semi-aromatic polyamide having a glass transition equal to or greater than 100° C. and a melting point equal to or greater than 280° C., as determined with differential scanning calorimetry at a scan rate of 20° C./min;
b) from about 0.1 to about 10 wt % of at least one hyperbranched aromatic polyamide having terminal alkycarboxamide groups; and
c) from 0 to about 80 wt % of a thermally conducting filler having a thermal conductivity of at least 5 W/mK.

Another embodiment is wherein said thermally conducting filler is present in about 10 to about 80 wt % and said thermally conducting filler is selected from the group consisting of zinc oxide, magnesium oxide, boron nitride, graphite flakes or fibers, calcium fluoride powder, and zinc sulfide

Another embodiment of the invention is a molded article comprising the composition as disclosed above.

The semi-aromatic thermoplastic polyamides useful in the invention are one or more homopolymers, copolymers, terpolymers, or higher polymers that are derived from monomers containing aromatic groups. Examples of monomers containing aromatic groups are terephthalic acid and its derivatives, isophthalic acid and its derivatives, p-xylylenediamine and m-xylylenediamine. It is preferred that about 5 to about 75 mole percent of the monomers used to make the aromatic polyamide used in the present invention contain aromatic groups, and more preferred that about 10 to about 55 mole percent of the monomers contain aromatic groups.

The semi-aromatic aromatic polyamide may be derived from dicarboxylic acids or their derivatives, such one or more of adipic acid, sebacic acid, azelaic acid, dodecanedoic acid, terephthalic acid, isophthalic acid or their derivatives and other aliphatic and aromatic dicarboxylic acids and aliphatic C₆-C₂₀ alkylenediamines, aromatic diamines, and/or alicyclic diamines. Preferred diamines include hexamethylenediamine; 2-methylpentamethylenediamine; 2-methyloctamethylenediamine; trimethylhexamethylenediamine; 1,8-diaminooctane; 1,9-diaminononane; 1,10-diaminodecane; 1,12-diaminododecane; and m-xylylenediamine. It may also be derived from one or more lactams or amino acids such as 11-aminododecanoic acid, caprolactam, and laurolactam.

The semi-aromatic polyamides useful in the invention have a glass transition equal to or greater than 100° C., preferably greater than 125° C.; and a melting point of equal to or greater than 280° C., and preferably greater than 290° C., and more preferably greater than 300° C. The glass transition and melting points defined herein are determined using differential scanning calorimetry at a scan rate of 20° C./min. The glass transition is defined as the mid-point of the transition in the second heating cycle. The melting point is defined as the point of maximum endotherm in the melting transition in the second heating cycle.

In one embodiment of the invention the semiaromatic polyamide is selected from the group consisting of poly(decamethylene terephthalamide) (polyamide 10,T), poly(nonamethylene terephthalamide) (polyamide 9,T), hexamethylene terephthalamide/2-methylpentamethylene terephthalamide copolyamide (polyamide 6,T/D,T); hexamethylene adipamide/hexamethylene terephthalamide/hexamethylene isophthalamide copolyamide (polyamide 6,6/6,T16,I); poly(caprolactam-hexamethylene terephthalamide) (polyamide 6/6,T); and hexamethylene terephthalamide/hexamethylene isophthalamide (6,T16,I) copolymer.

An especially preferred semiaromatic polyamide for the invention is hexamethylene terephthalamide/2-methylpentamethylene terephthalamide copolyamide (polyamide 6,T/D,T). This polyamide is commercially available as Zytel® HTN501 available from E.I. du Pont de Neumours, Wilmington, Del.

The semiaromatic polyamide component (a) is present in the composition in about 10 to 79.9 wt %, or more preferably in about 15 to about 50 wt %, where the weight percentages are based on the total weight of the thermoplastic composition.

Hyperbranched polyamides (HBPAs) useful in the invention are hyperbranched aromatic polyamides (HBAPAs) having terminal alkylcarboxamide groups. Hyperbranched aromatic polyamides refer to polyamides obtainable by polymerization of a single monomer selected from the group consisting of AZB₂, AZB₄, and AZB₈ monomers, with or without AZB monomers, wherein A is a carboxylic acid or ester; B is a primary amino group and Z is hydrocarbyl group having 1 to 20 aromatic rings selected from the group consisting of phenyl, biphenyl, naphthyl, pyridinyl, and pyrimidinyl; wherein said aromatic rings are linked by linking groups selected from covalent bonds, —O—, —S—, —C(O)—, and —C(O)NH—; to provide amine terminated hyperbranched aromatic polyamides; followed by acylation of at least 50% of the terminal amines to provide terminal alkylcarboxamide groups. Preferred HBAPA is hyperbranched wholly aromatic polyamide, that is, wherein Z contains no aliphatic, sp³ hybridized, carbon atoms. In one embodiment the HBAPA includes 0.1 to 50 mol % AZB monomer.

One embodiment of the invention is a composition wherein the HBAPA is derived from the polymerization of an AZB₂ monomer; wherein Z is selected from the group phenyl, biphenyl, naphthyl, and 4-phenoxy phenyl. Preferred AZB₂ monomers are selected from the group 3,5-diaminobenzoic acid, 3,5-bis(4-aminophenoxy)benzoic acid; C₁ to C₄ alkyl esters thereof, and combinations thereof. A more preferred AZB₂ monomer is 3,5-diaminobenzoic acid.

The terminal amine groups of the HBAPA preferably are modified with groups which provide less reactivity with semi-aromatic polyamide. Preferred end groups are acetamide, and C₃ to C₁₈ alkylcarboxamides. In one embodiment the HBAPA have C₃ to C₁₈ alkylcarboxamides. In another embodiment the HBAPA have acetamide end groups.

The HBAPAs useful in the invention can be provided by synthesis using well known procedures as disclosed in Macromolecules 2000, 33, 2832-2838; Macromolecules 1999, 32, 2215-2220; and J. Polym. Sci., Polym. Chem. Ed. 1981, 13, 1373.

The content of the hyperbranched aromatic polyamide in the thermoplastic composition is in a range of about 0.1 to about 10 wt %, and preferably about 0.3 to about 5 wt %, where the weight percentages are based on the total weight of the thermoplastic composition.

The thermal conductive filler useful in the invention is not particularly limited so long as the thermally conducting filler has a thermal conductivity of at least 5 W/mK and preferably at least 10 W/mK. Useful thermally conductive fillers are selected from the group consisting of oxide powders, flakes and fibers composed of aluminum oxide (alumina), zinc oxide, magnesium oxide and silicon dioxide; nitride powders, flakes and fibers composed of boron nitride, aluminum nitride and silicon nitride; metal and metal alloy powders, flakes and fibers composed of gold, silver, aluminum, iron, copper, tin, tin base alloy used as lead-free solder; carbon fiber, graphite flakes or fibers; silicon carbide powder; and calcium fluoride powder; and the like. These fillers may be used independently, or a combination of two or more of them may be used. Preferred thermally conducting fillers are selected from the group consisting of zinc oxide, magnesium oxide, boron nitride, graphite flakes or fibers, calcium fluoride powder, and zinc sulfide; and especially preferred thermally conducting filler is calcium fluoride powder.

Thermally conductive fillers can have a broad particle size distribution. If the particle diameter of the filler is too small, the viscosity of the resin may increase during blending to the extent that complete dispersion of the filler can not be accomplished. As a result, it may not be possible to obtain resin having high thermal conductivity. If the particle diameter of the filler is too large, it may become impossible to inject the thermally conductive resin into thin portions of the resin injection cavity, especially those associated with heat radiating members. Preferably, the maximum average particle size is less than 300 microns, and more preferably, less than 200 microns; as measured by using laser-diffraction type particle diameter distribution with a Selas Granulometer “model 920” or a laser-diffraction scattering method particle diameter distribution measuring device “LS-230” produced by Coulter K.K., for instance. Preferably, the average particle size is between 1 micron to 100 microns, and more preferably, between 5 microns to 60 microns. The particles or granules which have multi-modal size distribution in their particle size can also be used. An especially preferred thermally conductive filler is calcium fluoride having a particle size of from about 1 to 100 microns and preferably about 5 to about 60 microns.

The surface of the thermally conductive filler, or a filler having a thermal conductivity less than 5 W/mK (as disclosed below), can be processed with a coupling agent, for the purpose of improving the interfacial bonding between the filler surface and the matrix resin. Examples of the coupling agent include silane series, titanate series, zirconate series, aluminate series, and zircoaluminate series coupling agents.

Useful coupling agents include metal hydroxides and alkoxides including those of Group IIIa thru VIIIa, Ib, IIb, IIIb, and IVb of the Periodic Table and the lanthanides. Specific coupling agents are metal hydroxides and alkoxides of metals selected from the group consisting of Ti, Zr, Mn, Fe, Co, Ni, Cu, Zn, Al, and B. Preferred metal hydroxides and alkoxides are those of Ti and Zr. Specific metal alkoxide coupling agents are titanate and zirconate orthoesters and chelates including compounds of the formula (I), (II) and (III):

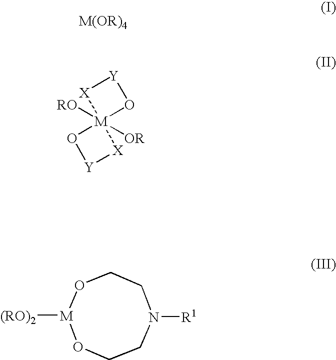

wherein

M is Ti or Zr;

R is a monovalent C₁-C₈ linear or branched alkyl;

Y is a divalent radical selected from —CH(CH₃)—, —C(CH₃)═CH₂—, or —CH₂CH₂—;

X is selected from OH, —N(R¹)₂, —C(O)OR³, —C(O)R³, —C(O)R³, —CO₂⁻A⁺; wherein

R¹ is a —CH₃ or C₂-C₄ linear or branched alkyl, optionally substituted with a hydroxyl or interrupted with an ether oxygen; provided that no more than one heteroatom is bonded to any one carbon atom;

R³ is C₁-C₄ linear or branched alkyl;

A⁺ is selected from NH₄⁺, Li⁺, Na⁺, or K⁺.

The coupling agent can be added to the filler before mixing the filler with the resin, or can be added while blending the filler with the resin. The additive amount of coupling agent is preferably 0.1 through 5 wt % or preferably 0.5 through 2 wt % with respect to the weight of the filler. Addition of coupling agent during the blending of filler with the resin has the added advantage of improving the adhesiveness between the metal used in the joint surface between the heat transfer unit or heat radiating unit and the thermally conductive resin.

The content of the thermally conductive filler in the thermoplastic composition is in a range of 20 to 80 wt %, and preferably 15 to 50 wt %, where the weight percentages are based on the total weight of the thermoplastic composition.

One aspect of the invention is a thermoplastic composition comprising components (a), (b) and (c) as defined above, wherein the thermoplastic plastic composition has a melt viscosity at 320° C., as measured as disclosed below; at least 10% lower, and preferably at least 30% lower, than that of a composition comprising components (a) and (c) and no component (b).

One aspect of the invention is a thermoplastic composition comprising components (a), (b) and (c) as defined above, wherein the thermoplastic composition has a weight loss of about 1 wt % or less, and preferably about 0.8 wt ° A) or less, as measured by thermogravimetric analysis at a scan rate of 20° C./min up to about 325° C., and holding at said 325° C. for 10 minutes.

The thermoplastic composition can include other fillers, flame retardants, heat stabilizers, viscosity modifiers, weatherability enhancers, and other additives known in the art, according to need. In one embodiment the thermoplastic composition, as disclosed above further comprises component (d) about 15 to about 50 wt % of filler having a thermal conductivity less than 5 W/mK. Fillers for component (d) are selected from the group consisting of glass fiber, glass fiber having a non-circular cross-section, wollastonite, talc, mica, silica, calcium carbonate, glass beads, glass flake, and hollow glass spheres. Preferred fillers are glass fiber and glass fiber having a non-circular cross section.

Herein glass fiber having a non-circular cross section refers to a glass fiber having a major axis lying perpendicular to a longitudinal direction of the fiber and corresponding to the longest linear distance in the cross section. The non-circular cross section has a minor axis corresponding to the longest linear distance in the cross section in a direction perpendicular to the major axis. The non-circular cross section of the fiber may have a variety of shapes including a cocoon-type (figure-eight) shape; a rectangular shape; an elliptical shape; a semielliptical shape; a roughly triangular shape; a polygonal shape; and an oblong shape. As will be understood by those skilled in the art, the cross section may have other shapes. The ratio of the length of the major axis to that of the minor access is preferably between about 1.5:1 and about 6:1. The ratio is more preferably between about 2:1 and 5:1 and yet more preferably between about 3:1 to about 4:1. Suitable glass fiber having a non-circular cross section are disclosed in EP 0 190 001 and EP 0 196 194. The glass fiber may be in the form of long glass fibers, chopped strands, milled short glass fibers, or other suitable forms known to those skilled in the art.

The thermoplastic composition useful in the invention can be made by methods well known in the art for dispersing fillers and other additives with thermoplastic resins such as, for example, single screw extruder, a twin screw extruder, a roll, a Banbury mixer, a Brabender, a kneader or a high shear mixer.

The composition of the present invention may be formed into articles using methods known to those skilled in the art, such as, for example, injection molding. Such articles can include those for use in electrical and electronic applications, mechanical machine parts, and automotive applications. Articles for use in applications that require high thermal conductivity and low moisture absorption are preferred. An embodiment of the invention is a molded article provided by the thermoplastic composition, and preferred embodiments, as disclosed.

The thermoplastic compositions of the invention are especially useful In the electrical/electronics area. For instance they can be used in applications such as hybrid electric motors, stators, connectors, coil formers, motor armature insulators, light housings, plugs, switches, switchgear, housings, relays, circuit breaker components, terminal strips, printed circuit boards, and housings for electronic equipment.

### Methods

The polymeric compositions shown in Table 2 were prepared by compounding Zytel HTN501 and HBAPAs using a 15-mL conical twin-screw micro-compounder, available under the trade designation “DSM RESEARCH 15 ml MICRO-COMPOUNDER” from DSM Xplore, The Netherlands. The temperatures of top, center and bottom heating zones for the micro-compounder were 295° C., 325° C. and 330° C., respectively. The screw speed is 250 rpm. The blend was added to the micro-compounder using the manually operated feed hopper, with a total charge size of 15.0 g. After the materials were fed, the manual feed hopper was removed, and the plugging insert was inserted into the feed port. Once the feed port was plugged, the sample was recirculated in the compounder for exactly three minutes. Midway through the mixing cycle, the force was recorded for each sample. After the 3-minute mixing, the composition was extruded as a strand into a plate flowing with water at room temperature, and cut into pellets.

Melt viscosity (MV) of all Examples were measured using a Kayeness rheometer. The melt viscosities of Examples 1-6 and C-1-C-4 were measured at a shear rate of 1000/second and at a temperature of 320° C. after a residence time of 5 min in each example. Examples C-3, C-4 and 7 and 8 were measured at a shear rate of 1000/second and at a temperature of 325° C. after a residence time of 5 min in each example.

Molecular weights were determined by gel permeation chromatography with a Shodex GPC104 instrument with the following specifications: column type: Shodex GPC HFIP 606M×2, solvent: hexafluoroisopropanol (HFIP) with 5 mM sodium trifluoroacetate, flow rate: 0.3 mL/min, detector: refractive index and column temperature: 40° C. Standard: poly(methyl methacrylate).

Weight loss was measured by thermogravimetric analysis (TGA) under air. TGA was conducted on an Auto TGA 2950 V5.4A instrument (TA Instruments). In each case, a 15-30 mg sample (cut from pellet) was positioned in aluminum pans. The weight loss of HBAPAs in Table 1 was measured as follows: the temperature was increased at 20° C./min from 23° C. to 325° C. and the weight loss was measured in weight % relative to the initial weight at 325° C. The weight loss of examples in Table 2 was measured as follows: the temperature was increased at 20° C./min from 23° C. to 325° C. and then held at 325° C. for 10 min. At the end of that period the weight loss was measured in weight % relative to the initial weight.

Glass transition temperature (Tg) and melting temperature (Tₘ) were measured by differential scanning calorimetry (DSC) within the temperature range of 23° C. to 330° C. at a heating rate of 20° C./min under Nitrogen.

### Materials

Zytel® HTN 501 resin is a polyamide 6,T/D,6 copolymer, available from E.I. du Pont de Neumours, Wilmington, Del.

CaF2 refers to Calcium fluoride powder with an average size 6 microns manufactured by Sankyo Seifun Co., Ltd.

Boltorn® H2O dendritic polyester polymer with hydroxyl end groups was obtained from Perstorp Specialty Chemicals, Perstorp, Sweden.

HBAPA-1 (acetamide terminated polymer). Hyper-branched polyamides used in the examples were prepared by synthesis. First, an amino terminated hyper-branched polyamide (HBAPA-NH₂) was prepared by direct condensation of 3,5-diaminobenzoic acid using triphenyl phosphite (TPP)/pyridine system as disclosed in Kakimoto, et al, Macromolecules 2000, 33, 2832-2838. The resulting HBAPA-NH₂ polymer was treated with excess (based on amino groups) acetyl chloride in dimethylacetamide according to procedures disclosed in Macromolecules 1999, 32, 2215-2220; to provide HBAPA-1.

HBAPA-2 (heptanamide terminated polymer). HBAPA-NH₂ polymer was treated with excess (based on amino groups) heptanoyl chloride in dimethylacetamide according to procedures disclosed in Macromolecules 1999, 32, 2215-2220; to provide HBAPA-2.

Properties of HBAPA-1 and HBAPA-2 are listed in Table 1.

TABLE 1

| | | End- | | Weight |
|---|---|---|---|---|
| | | capping | Mw | loss, |
| | Monomer | agent | Mw/Mn | 325° C., % |
| HBAPA- | 3,5- | Acetyl | 17600^{a} | 5 |
| 1 | diaminobenzoic | chloride | 2.15 | |
| | acid | | | |
| HBAPA- | 3,5- | Heptanoyl | 20900 | 18 |
| 2 | diaminobenzoic | chloride | 2.49 | |
| | acid | | | |

^{a}slightly soluble in hexafluoroisopropanol (5 mM sodium trifluoroacetate)

### EXAMPLES

Examples 1-6, compositions including HBAPA, exhibited significant reductions in melt viscosity compared to Comparative Example C-1. Examples 1-6 further exhibited significantly lower weight loss (by TGA) than conventional polyester based viscosity modifiers.

TABLE 2

| Example | C-1 | C-2 | 1 | 2 | 3 | 4 | 5 | 6 |
|---|---|---|---|---|---|---|---|---|
| Composition | | | | | | | | |
| (wt %) | | | | | | | | |
| Zytel ®HTN501 | 100 | 95 | 98 | 95 | 90 | 98 | 95 | 90 |
| HBAPA-1 | | | 2 | 5 | 10 | | | |
| HBAPA-2 | | | | | | 2 | 5 | 10 |
| Boltorn ® H20 | | 5 | | | | | | |
| Properties | | | | | | | | |
| Melt Viscosity | 125 | 5 | 88 | 53 | 18 | 68 | 39 | 6 |
| (Pa · s) | | | | | | | | |
| Mw (g/mol) | 24200 | 13900 | 21800 | 19000 | 15400 | 20200 | 17100 | 13300 |
| Weight Loss | 0.6 | 2.8 | 0.6 | 0.9 | 1.3 | 0.8 | 1.0 | 1.7 |
| (%) | | | | | | | | |
| T_{g} (° C.) | 139 | 126 | 140 | 140 | 134 | 141 | 141 | 142 |
| Tₘ (° C.) | 301 | 300 | 306, | 305, | 303, | 304, | 304, | 303, |
| | | | 256 | 254 | 249 | 252 | 248 | 249 |

TABLE 3

| Example | C-3 | C-4 | 7 | 8 |
|---|---|---|---|---|
| Composition (wt %) | | | | |
| Zytel ®HTN501 | 40 | 38 | 38 | 38 |
| HBAPA-1 | | | 2 | |
| HBAPA-2 | | | | 2 |
| Boltorn ® H20 | | 2 | | |
| CaF2 | 60 | 60 | 60 | 60 |
| Properties | | | | |
| Thermal Conductivity | 0.8 | 0.8 | 0.8 | 0.8 |
| (W/mK) | | | | |
| Melt Viscosity (Pa · s) | 434 | 179 | 257 | 235 |
| Weight Loss (%) | 0.3 | 1.5 | 0.5 | 0.6 |
| T_{g} (° C.) | 139 | 126 | 140 | 141 |

1. A thermoplastic composition comprising:
a) from about 10 to about 99.9 wt % of at least one semi-aromatic polyamide having a glass transition equal to or greater than 100° C. and a melting point equal to or greater than 280° C., as determined with differential scanning calorimetry at a scan rate of 20° C./min;
b) from about 0.1 to about 10 wt % of at least one hyperbranched aromatic polyamide having terminal alkylcarboxamide groups; and
c) from 0 to about 80 wt % of a thermally conducting filler having a thermal conductivity of at least 5 W/mK.

2. The thermoplastic composition of claim 1 wherein said thermally conducting filler is present in about 10 to about 80 wt % and said thermally conducting filler is selected from the group consisting of zinc oxide, magnesium oxide, boron nitride, graphite flakes or fibers, calcium fluoride powder, and zinc sulfide.

3. The thermoplastic composition of claim 2 wherein said thermally conducting filler is calcium fluoride.

4. The thermoplastic composition of claim 1 wherein said at least one semi-aromatic polyamide is selected from the group consisting of poly(decamethylene terephthalamide), poly(nonamethylene terephthalamide), hexamethylene terephthalamide/2-methylpentamethylene terephthalamide copolyamide; hexamethylene adipamide/hexamethylene terephthalamide/hexamethylene isophthalamide copolyamide; poly(caprolactam-hexamethylene terephthalamide); and hexamethylene terephthalamide/hexamethylene isophthalamide copolymer.

5. The thermoplastic composition of claim 1 wherein said at least one semi-aromatic polyamide is hexamethylene terephthalamide/2-methylpentamethylene terephthalamide copolyamide.

6. The thermoplastic composition of claim 1 wherein the hyperbranched aromatic polyamide has repeat units obtainable by reaction of one or more monomers selected from the group consisting of AZB₂, AZB₄, and AZB₈ monomers, wherein A is a carboxylic acid or ester; B is a primary amino group and Z is hydrocarbyl group having 1 to 20 aromatic rings selected from the group consisting of phenyl, biphenyl, naphthyl, pyridinyl, and pyrimidinyl; wherein said aromatic rings are linked by linking groups selected from covalent bonds, —O—, —S—, —C(O)—, and —C(O)NH—.

7. The thermoplastic composition of claim 1 wherein the hyperbranched polyamide has repeat units obtainable by reaction of 3,5 diaminobenzoic acid.

8. The thermoplastic composition of claim 1 or 2 further comprising
d) about 15 to about 50 wt % of a filler having a thermal conductivity less than 5 W/mK.

9. A molded article comprising the composition of claim 1 or 8.
